(19) United States
(12) Patent Application Publication
(10) Pub. No.: US 2018/0236923 A1
(43) Pub. Date: Aug. 23, 2018

(54) LINKAGE BREAKING PARALLEL ARM

(71) Applicant: Waltco Lift Corp., Tallmadge, OH (US)

(72) Inventor: James Wu, Tallmadge, OH (US)

(21) Appl. No.: 15/899,847

(22) Filed: Feb. 20, 2018

Related U.S. Application Data
(60) Provisional application No. 62/460,968, filed on Feb. 20, 2017.

(51) Int. Cl. B60P 1/44; B65G 67/04; B65G 69/00

(52) U.S. Cl. CPC B60P 1/445; B60P 1/4485; B65G 69/001; B65G 67/04

(57) ABSTRACT

Provided is an elevating platform assembly comprising: a pair of spaced linkage arms having a platform end and a frame end; wherein each pair of spaced linkage arms comprise an upper-arm and lower-arm; the upper-arm consisting of a platform link hingedly connected to a frame link; adjustable platform stops adjustably connected to bottom portions of the frame links and adapted to engage a bottom edge of the platform links; wherein the adjustable platform stop is capable of adjusting a connection angle between the hingedly connected platform link and frame link resulting in a leveling adjustment for an attached horizontal platform extending between and connected to the platform ends of the spaced linkage arms; and wherein the horizontal platform is capable of moving between a lowered position on the ground to a raised position in substantial alignment with a loading platform.

### TECHNICAL FIELD

The present disclosure relates to elevating platforms, specifically elevating platform assemblies including an adjustable platform stops and two-piece upper linkage arms to maintain a level platform during platform travel to and from raised and lowered positions. It finds particular application in conjunction with loading vehicles such as trucks and will be described with particular reference thereto. However, it is to be appreciated that the present disclosure is also amenable to other like applications.

### BACKGROUND

Often parcels are too large or heavy for a person to easily pick up and load into the back or bed of a truck. Elevating platforms have helped solve this issue. These assemblies usually include a platform, a frame mount for attachment to a vehicle, a set of linkage arms connecting platform to the frame mount, and a means for mechanically moving the platform to raised and lowered positions. Because the load could be large and/or heavy, it is important that the platform, on which the parcel rests, to be level during use. A challenge in the industry is to create a platform assembly that provides a substantially level platform at all times, during operation from lowered to raised positions and throughout the lifetime of the elevating platform assembly.

Through frequent use and wear and tear over time, parts or materials of the elevating platform/lift gate assembly could become loose, sag, and become fatigued, and the level of the platform could be changed or angled.

Hence there is a need for an elevating platform assembly that can support significant weight and maintain level operation throughout the lifetime of the product wherein the position of the platform, i.e. angle, can be corrected.

### SUMMARY

Provided is a system and assembly for elevating platforms. In one embodiment, the elevating platform includes a platform, a frame connection means, and a set of lift linkage arms on each side of the platform to connect the platform to the frame connection means. The frame connection means attaches the platform assembly to the frame of a truck or dock.

In one embodiment the platform is connected to the rear of a truck or loading dock though linkage arms. One or more hydraulic cylinders are connected to the linkage system such that when activated, extend or retract to swing the platform from the ground to an elevated position and vice versa. The linkage system includes a pair of parallel arms, an upper-arm and lower-arm, on each side of the elevating platform assembly.

In another embodiment, the upper parallel arm includes two parts, which are connected by a hinge. The hinged connection allows the arms to “break” when the lift is stowed and extend when the lift is lowered. In another embodiment, at the hinge, an adjustable stop prevents the arms from extending beyond a desired position. The stop does not affect the stowage of the lift.

In another embodiment of the disclosure, the position of the stop keeps the platform in a substantially level position relative to the ground. Adjustment of the stop is performed during installation of the elevating platform assembly on the truck or dock. Once the platform is substantially level after installation, the stop is no longer adjusted except for instances where the stop may have shifted or the platform is otherwise not level from wear and tear.

In another embodiment of the disclosure, the elevating platform assembly further includes a hydraulic system. The hydraulic system includes a powered pump and a pair of hydraulic actuators that connect between the lift linkage and the frame, and operate to raise and lower the platform upon extension and retraction of the actuators.

The platform can support significant weight and can fold to a stowed position under the rear of the vehicle when not in use. When in use, the platform can be raised to a level substantially even with the bed of the vehicle, and can be lowered to rest on the ground. The adjustable platform stop, in conjunction with the design of the lift linkage, upper arm, platform support, and frame, allows the platform to remain level during operation. In another embodiment, the elevating platform assembly also includes an extension to the bed of the vehicle providing a continuous connection from the bed to the platform when the platform is in the raised position.

### BRIEF DESCRIPTION OF THE DRAWINGS

Features and advantages of the invention will become more apparent from the following detailed description made with reference to the accompanying drawings, wherein;

FIG. 1 is a perspective view of a elevating platform assembly;

FIG. 2 is an enlarged perspective view of a linkage system;

FIG. 3 is a photo of an upper-arm of an elevating platform assembly;

FIG. 4 is a photo of an installed hydraulic cylinder of an elevating platform assembly;

FIG. 5 is an enlarged perspective view of a linkage system and underride bar;

FIG. 6 is a photo illustrating a stowed platform;

FIG. 7 is a top perspective view of a hydraulic attachment;

FIG. 8 is a photo illustrating a stowed platform and storage stop.

### DETAILED DESCRIPTION

A more complete understanding of the components, process, and apparatuses disclosed herein can be obtained by reference to the accompanying figures. These figures are merely schematic representation based on convenience and the ease of demonstrating the present disclosure of the devices or components thereof.

The present disclosure provides elevating platform assemblies.

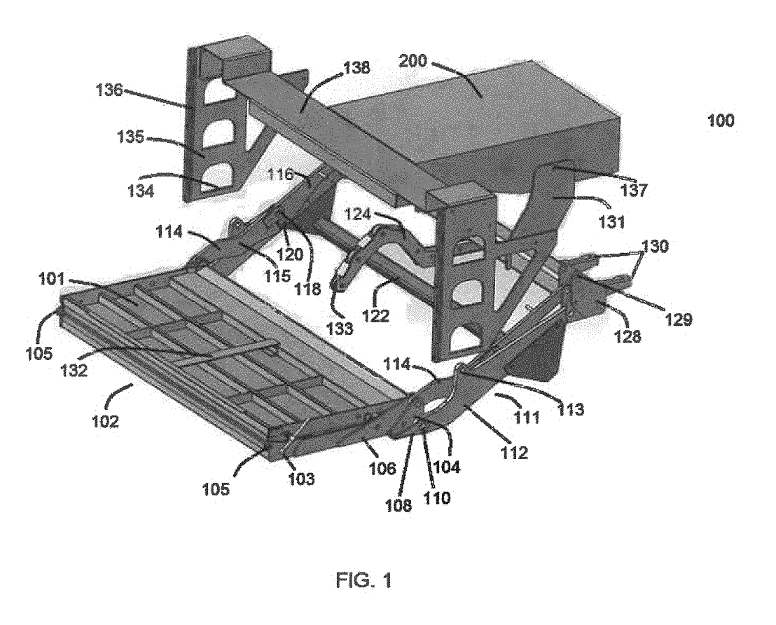

Accordingly, FIG. 1 illustrates a perspective view of an elevating platform in accordance with one embodiment of the disclosure. The elevating platform assembly 100 includes a folding platform 102. The folding platform 102 is composed of two parts, a platform extension 101 hingedly attached to platform body 103. Hinge connections 105 allow the platform extension 101 unfold and provide a platform area sufficient for loading and unloading parcels of combined platform body 103 and platform extension 101. When the elevating platform is not in use, platform extension 101 can rotate about hinge connections 105 to ‘fold’ onto platform body 103.

The folding platform 102 is supported by platform support 106, connected to the platform body 103. The folding platform and support are connected to the to the linkage system though linkage means 104. The linkage means 104 includes bottom plate 108 and lower pin 104. The lower pin 104 defines the rotation axis of the back of the folding platform body 103 and allows the entire folded folding platform 102 to rotate up to be stowed.

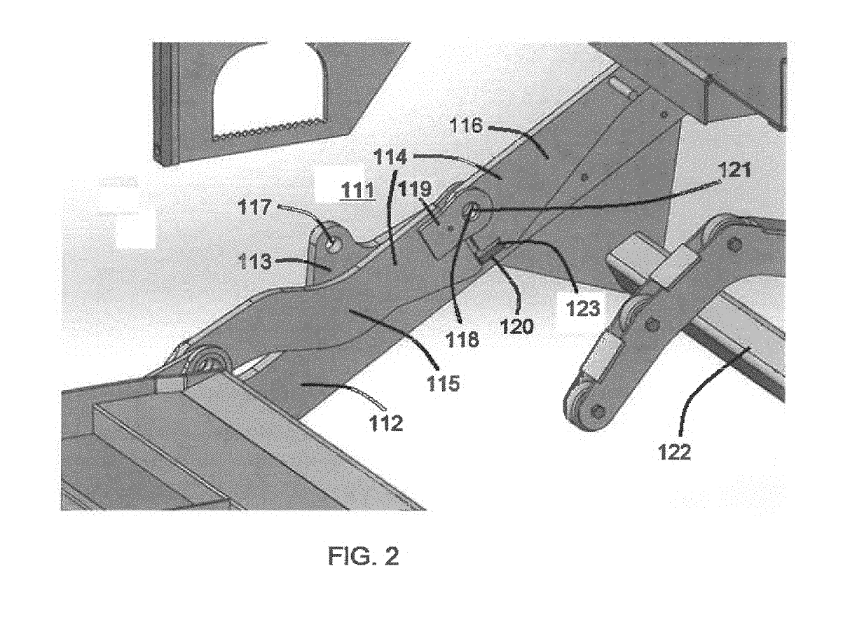

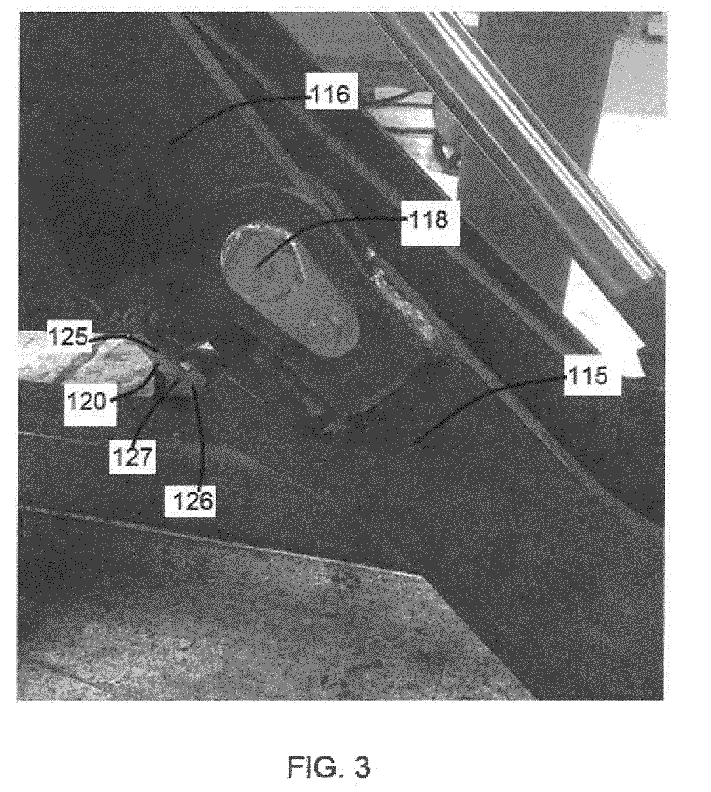

In one embodiment, as highlighted in FIG. 2 and FIG. 3, the linkage system 111 includes lower-arms 112 and upper-arms 114. Upper-arms 114 are two-piece arms composed of a platform links 115 connected to frame links 116. The links are connected by joint plates 119. The joint plates 119 are permanently or semi-permanently fixed to the ends of platform links 115. The joint plates include apertures 121 which are substantially aligned with pivot points 118 of the frame links 116. A pin though the apertures 121 and pivot point 118 creates a hinge attachment and allows rotation of the platform link about the pivot point 118. When the platform is rotated to be stowed the two-piece linkage arms “break” at the pivot points 118 allowing rotation for the folding platform to be stored under the bed 200 of a vehicle. In another embodiment, the linkage system 111 also includes adjustable platform stops 120 which engage the upper-arm links 115 and 116, respectively, to hold the platform level. In some embodiments the adjustable platform stop is threaded or mounted such that it can be adjusted, into a recess 123 of the frame link 116. The adjustable platform stop 120 prevents the platform link 115, and thus the platform 102, from rotating too far and maintains the platform 120 in a level position.

In one embodiment the adjustable stop 120 includes a threaded body 125 attached to the frame link 116 in recess 123 and capable of receiving a threaded bolt 126. The threaded body 125 can be attached to the frame link with a bolt, a weld, or any means known in the art. A matched threaded bolt 126 screws into the threaded body. Adjustment of the platform level is accomplished by further screwing or unscrewing of the threaded bolt 126 to shorten or lengthen the adjustable stop 120. In another embodiment washers 127 can be added to fill any space created between the head of the bolt 126 and threaded body 125.

In one embodiment the adjustable stop is a locking nut arrangement. This arrangement prevents the adjustable stop from loosening during vibrations or though wear and tear overtime.

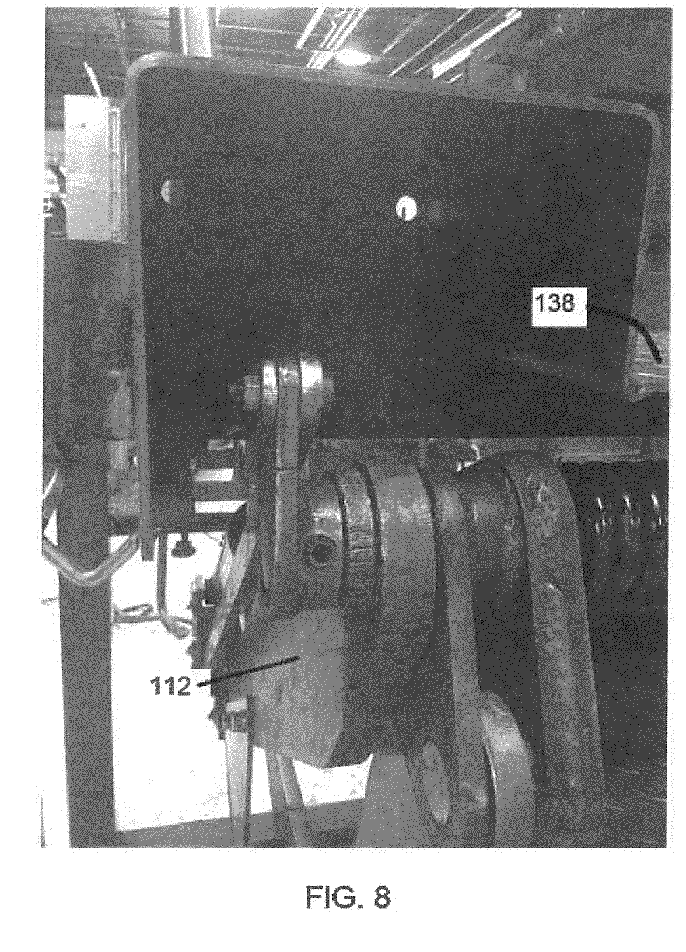

In one embodiment of the disclosure, a roll strip 132 is located on the underside of platform extension 101. When the folding platform 102 is folded, as illustrated in FIG. 1, the underside of the platform extension 101 is exposed, and roll strip 132 can be seen. During the storage/stowing process, folding platform 102 is rotated about the lower pin and pivot point 110 causing the upper-arms 114 to break. The rotation is stopped by the stow support arm 124 when the support arm wheels 133 come in contact with the folded platform roll strip 132. During completion of the storage/stowing process, the folded folding platform 102 is guided into position while the roll strip 132 is in contact with the wheels 133 of stow arm 124. When the platform is stowed, the platform support 106 is inverted and bottom plate 108 on the bottom surface contacts a storage stop, see FIG. 8.

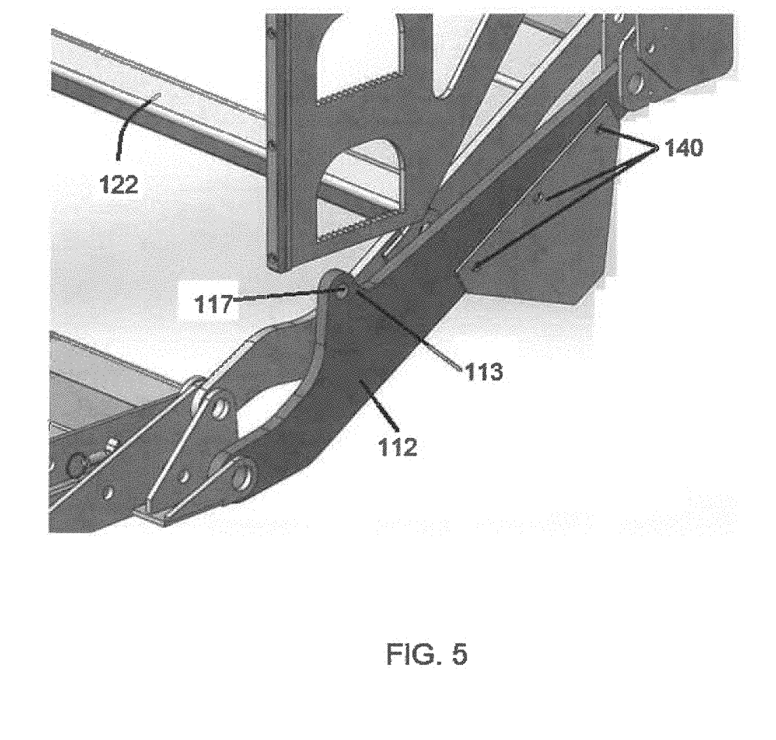

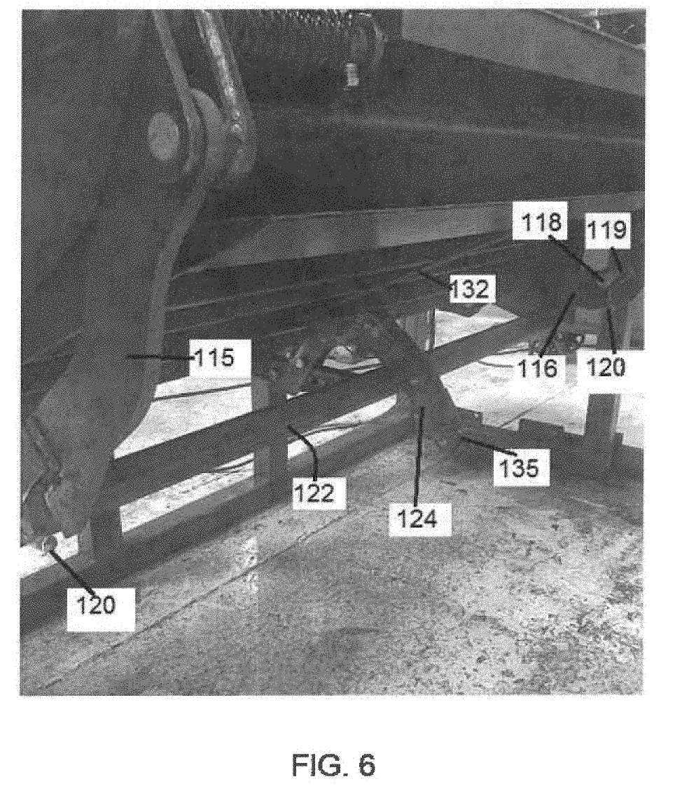

In another embodiment of the disclosure, as illustrated in FIG. 1, and FIG. 5, an underride bar 122 connects the linkage sets together by attachment to both lower-arms 114. The underride bar 122 is attached to the outside of lower-arm 112 with bolts 140. The underride bar provides additional stability of the platform assembly. Additionally, when the folding platform is in the stowed position as seen in FIG. 6, the underride bar 122 becomes the lowest point of the platform assembly to the ground and the underride bar provides impact protection to the vehicle.

In one embodiment of the disclosure, the platform assembly 100 is connected to the frame of a vehicle through frame connection 131 and apertures 137. In some embodiments, bolts are used to secure the frame connection 131, though apertures 137, to the frame of a vehicle. In another embodiment, when connected, a bed extension 138 fills the gap between the edge of the vehicle bed and the folding platform in the elevated position. When the platform is raised the bed extension 138, platform body 103, and platform extension 101 provide a continuous surface for loading parcels to and from the vehicle.

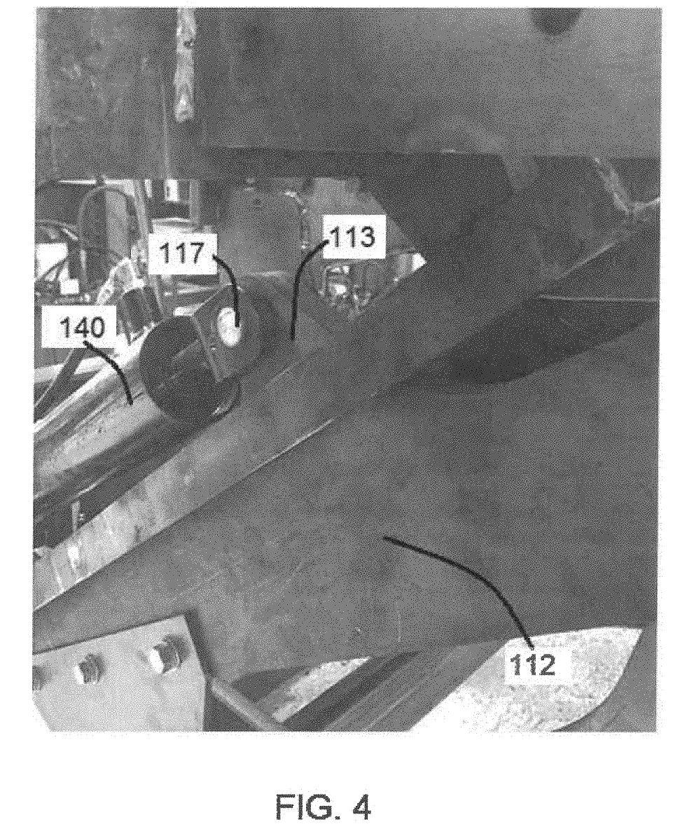

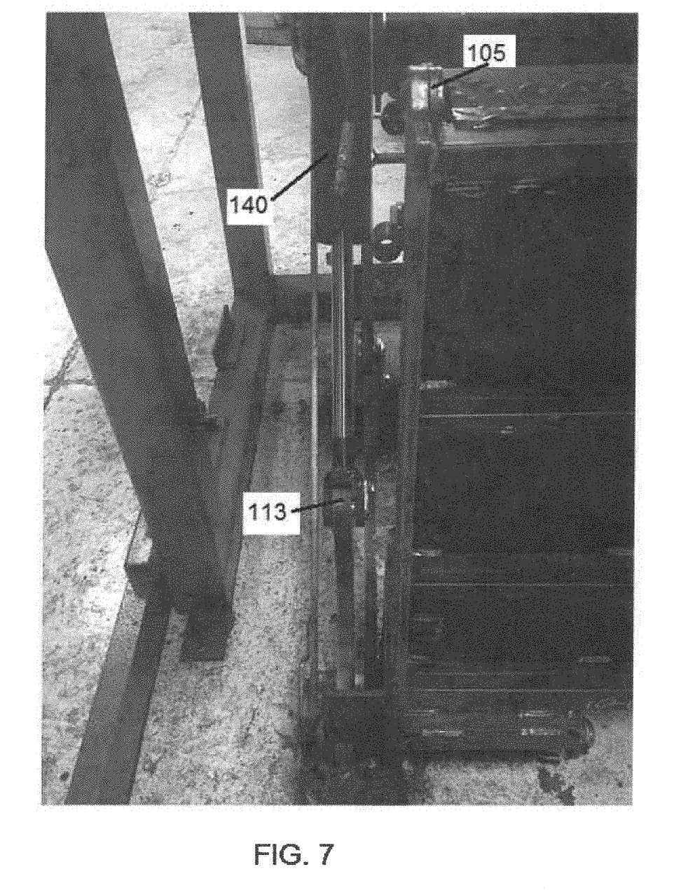

In one embodiment of the disclosure, a hydraulic system is mounted to the platform assembly in order to raise and lower the folding platform 102. The photo in FIG. 4 and top view FIG. 7 show a lower-arm 112 of the linkage system 111 including lower-arm ear 113 with aperture 117. The apertures 117 of ears 113 accommodate the connection of one end of a hydraulic cylinder 140. The connection could be provided via a nut and bolt, pin, or any other connection known in the art. In another embodiment, the other ends of the hydraulic cylinders 140 are attached to the hydraulic motor mount plates 128 via motor mount apertures 129 as seen in FIG. 1. The motors, not pictured, are attached to the platform assembly 100 at hydraulic motor mounts 130. The motors operate the hydraulic cylinders, controlling the extension and retraction of the cylinders, in order to lower and raise the platform.

In one embodiment of the disclosure, assembly guards 135 are connected to the bed extension 138. The guards 135 include a plurality of steps 134 and dock bumpers 136. The dock bumpers 136 extend along the rear length of the guards 135. When the folding platform 102 is in the stowed position, the dock bumpers 136 extend beyond the edge of the bed extension plate 138 and are the rear-most point of the installed platform assembly. The dock bumpers thus are positioned to provide cushion for low speed impacts with a loading dock when the vehicle is backed into a loading bay.

Having thus described the disclosed assembly and system, it is now claimed:

What is claimed is:

1. An elevating platform assembly comprising:
a pair of spaced linkage arms having a platform end and a frame end and comprising an upper-arm and lower-arm;
wherein each upper-arm consists of a platform link hingedly connected to a frame link;
an adjustable platform stop adjustably connected to bottom portion of each frame link and adapted to engage a bottom edge of each platform link;
wherein the adjustable platform stop is capable of adjusting a connection angle between the hingedly connected platform link and frame link resulting in a leveling adjustment for an attached horizontal platform extending between and connected to the platform ends of the spaced linkage arms; and
wherein the horizontal platform is capable of moving between a lowered position on the ground to a raised position in substantial alignment with a loading platform.

2. The elevating platform assembly of claim 1 wherein recesses are cut into the bottom edge of frame link closest to the platform link and configured to accept a platform stop.

3. The elevating platform assembly of claim 2 wherein the platform stop comprises:
a threaded body permanently connected to the frame link recesses and adapted to receive a threaded bolt; and
a threaded bolt;
wherein the threaded bolt contacts the lower edge of the platform link and position of the threaded bolt determines the connected angle between the platform and frame links.

4. The elevating platform assembly of claim 1 further comprising:
a bed extension plate having a top surface, a bottom surface, a left outside surface, a right outside surface, a front edge, and a back edge wherein the top surface of the bed extension plate covers a gap created by the loading platform and the elevating platform in a raised position.

5. The platform assembly according to claim 4 wherein dock guards having a rear surface are bolted to the outside surfaces of the bed extension plate; wherein when the elevating platform is stowed, the dock guard rear surfaces extend beyond the back edge of the bed extension plate and are the rear-most point of the installed platform assembly; and wherein a resilient bumper is attached to the rear surface of the dock guards.
